(19) United States
(12) Patent Application Publication
(10) Pub. No.: US 2014/0172572 A1
(43) Pub. Date: Jun. 19, 2014

(54) SYSTEMS AND METHODS TO PROVIDE RECOMMENDATIONS

(71) Applicant: Jeremiah Joseph Akin, Pleasant Hill, CA (US)

(72) Inventor: Jeremiah Joseph Akin, Pleasant Hill, CA (US)

(73) Assignee: eBay Inc., San Jose, CA (US)

(21) Appl. No.: 13/720,406

(22) Filed: Dec. 19, 2012

(51) Int. Cl. G06Q 30/02

(52) U.S. Cl. CPC G06Q 30/0261
USPC 705/14.58

(57) ABSTRACT

Methods and systems relating to providing a recommendation on a client device are described. In some embodiments, data from a sensor included in the client device is received. The sensor is configured to obtain data corresponding to a location and a direction of the client device. User movement information is determined based on the data from the sensor. A recommendation is identified based on the user movement information. The recommendation is sent to the client device.

### TECHNICAL FIELD

This application generally relates to systems and methods for providing recommendations.

### BACKGROUND

Many people travel to various places. Traveling may include driving, taking a flight, or using the waterways. If a person is driving for a period of time, he may need help identifying places that are in the vicinity and that are en route. Once the person has arrived at his destination, he may need help identifying places near the destination.

### BRIEF DESCRIPTION OF THE DRAWINGS

Some embodiments are illustrated by way of example, and not as limitation, in the accompanying figures.

FIG. 1 is a network diagram depicting an example system for providing recommendations, according to some embodiments;

FIG. 2 is a block diagram illustrating an example environment for operating a mobile device to provide recommendations, according to some embodiments;

FIG. 3 is a flowchart illustrating an example method for providing recommendations, according to some embodiments;

FIG. 4 is an interface diagram of an example user interface for providing recommendations on a mobile device, according to some embodiments;

FIG. 5 is an interface diagram of another example user interface for providing recommendations on a mobile device, according to some embodiments;

FIG. 6 is an interface diagram of another example user interface for providing recommendations on a mobile device, according to some embodiments;

FIG. 7 is an interface diagram of another example user interface for providing recommendations on a mobile device, according to some embodiments;

FIG. 8 is an interface diagram of another example user interface for providing recommendations on a mobile device, according to some embodiments; and

FIG. 9 is a block diagram of a machine in the example form of a computer system within which a set of instructions for causing the machine to perform any one or more of the methodologies discussed herein, according to some embodiments.

### DETAILED DESCRIPTION

Example systems and methods relating to providing recommendations based on user movement are described. In the following description, for purposes of explanation, numerous specific details are set forth in order to provide a thorough understanding of example embodiments. It will be evident, however, to one skilled in the art that the present technology may be practiced without these specific details.

A mechanism to provide recommendations on a client device is provided. The mechanism may be implemented as a recommendations application that runs on the client device. The recommendation application may be in communication with a server that may perform some of the functionalities described herein. The client device includes a sensor that detects and obtains data related to a location and a direction of the client device. The sensor may include a GPS and/or a compass. The data corresponding to the location and direction of the client device is received at the server. User movement information is determined from the data from the sensors. The user movement information may include information related to the direction that the client device is traveling or moving and a speed at which the client device is moving. The user movement information may also include a current location of the client device.

Once the user movement information is determined, information corresponding to a business or an entity is obtained based on the user movement information. For example, a business or entity may include, but is not limited to, a gas station, a restaurant, a hotel, a tourist attraction, and the like. A recommendation for a business or entity is identified from this information. The recommendation is also identified based on the user movement information. For example, the recommendation for a business is provided to the client device, where the business is located on a route that the user of the client device is traveling or the business is located near the user's current location. When the recommendation application determines that the user is driving, the recommendation application provides recommendations that are relevant to the user's driving route. In that case, gas stations and fast food restaurants may be more relevant than tourist attractions. When the recommendation application determines that the user has been stopped at a particular location for a period of time (such as a few days), the recommendation application provides recommendations that are relevant to the user's stay in that particular location. In that case, recommendations for tourist attractions and hotels may be more relevant than gas stations. The recommendation application can run in the background on the client device and determine the type of services in which the user may be interested based on the user's movement patterns. The recommendation application can also obtain additional information related to a business, such as coupons, deals, check-in specials, etc. This information may be obtained by integrating with other applications, websites, and servers. The recommendation application thus provides recommendations by automatically determining user movement and requiring minimal user input regarding user location.

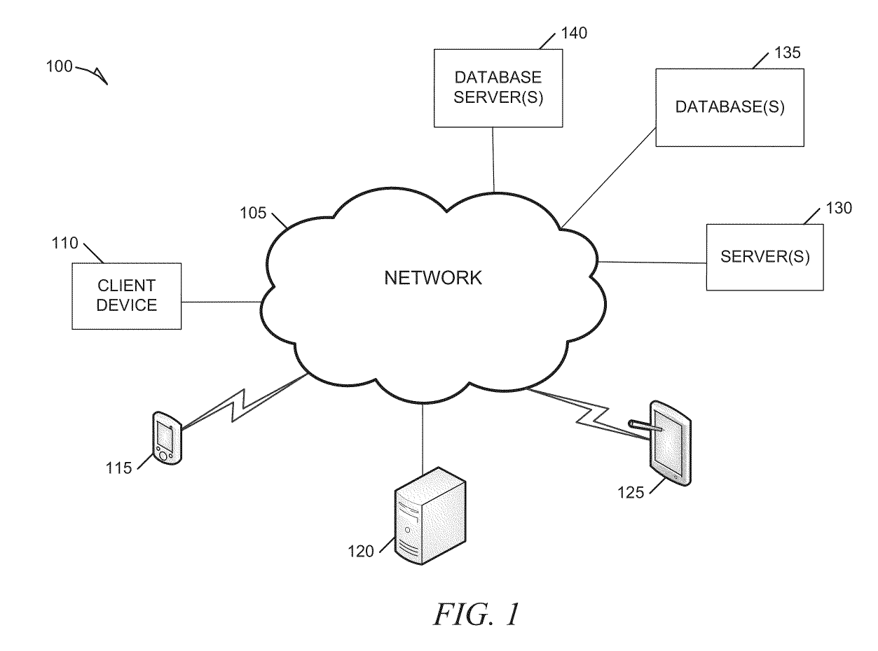

FIG. 1 is a network diagram depicting an example system 100 for providing recommendations. The system 100 can include a network 105, a client device 110, a client device 115, a client device 120, a client device 125, a server(s) 130, a database(s) 135, and a database server(s) 140. Each of the client devices 110, 115, 120, 125, server(s) 130, database(s) 135, and database server(s) 140 is in communication with the network 105.

In an example embodiment, one or more portions of network 105 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The client devices 110, 115, 120, 125 may comprise, but are not limited to, work stations, computers, general purpose computers, Internet appliances, hand-held devices, wireless devices, portable devices, wearable computers, cellular or mobile phones, portable digital assistants (PDAs), portable navigation systems, vehicle installed navigation systems, smart phones, tablets, ultrabooks, netbooks, laptops, desktops, multi-processor systems, microprocessor-based or programmable consumer electronics, game consoles, set-top boxes, network PCs, mini-computers, smartphones, tablets, and the like. Each of client devices 110, 115, 120, 125 may connect to network 105 via a wired or wireless connection. Each of client devices 110, 115, 120, 125 may include one or more applications (also referred to as “apps”) such as, but not limited to, a web browser, a notification application, a maps/directions application, an application that provides deals/coupons (such as Groupon, Google Offers), social media applications (such as Facebook, Foursquare), a recommendation application described herein, and the like. In some embodiments, the recommendation application included in any of the client device 110, 115, 120, 125 may be configured to locally provide a user interface, locally perform functionalities described herein, and communicate with server(s) 130, database(s) 135, and database server(s) 140 via network 105 for data not locally available (such as information related to businesses, deals, maps, directions, etc.). Each of client devices 110, 115, 120, 125 may include one or more sensors that detect and obtain data related to the location and direction of movement of the client device, such as a global positioning system (GPS), a compass, and the like.

In some embodiments, the recommendation application may be included on the client device 110, 115, 120, 125, and the server 130 performs the functionalities described herein. The server 130 may receive data from the sensors included on the client device 110, 115, 120, 125, and determine user movement based on the data. The server 130 may obtain information related to businesses and identify recommendations based on the user movement. The server 130 may configure the recommendations according to a user preference and send them to the client device 110, 115, 120, 125 to display. These functionalities may be performed by one or more servers.

In another embodiment, the recommendation application included in the any of the client devices 110, 115, 120, 125 may be configured to locally perform some of the functionalities described herein, while the server 130 performs the other functionalities described herein. For example, the client device 110, 115, 120, 125 may gather sensor data and determine user movement based on the data. The server 130 may obtain information related to businesses and identify recommendations based on the user movement determined by the client device 110, 115, 120, 125. The server 130 may send the recommendations to the client device 110, 115, 120, 125. The client device 110, 115, 120, 125 may configure the recommendations according to a user preference and display the recommendations on the client device 110, 115, 120, 125.

Each of the server(s) 130, database(s) 135, and database server(s) 140 is connected to the network 105 via a wired connection. Alternatively, one or more of the server(s) 130, database(s) 135, or database server(s) 140 may be connected to the network 105 via a wireless connection. Although not shown, database server(s) 140 can be (directly) connected to database(s) 135, or server(s) 130 can be (directly) connected to the database server(s) 140 and/or database(s) 135. Server(s) 130 comprises one or more computers or processors configured to communicate with client devices 110, 115, 120, 125 via network 105. Server(s) 130 hosts one or more applications or websites accessed by client devices 110, 115, 120, 125, and/or facilitates access to the content of database(s) 135. Database server(s) 140 comprises one or more computers or processors configured to facilitate access to the content of database(s) 135. Database(s) 135 comprise one or more storage devices for storing data and/or instructions for use by server(s) 130, database server(s) 140, and/or client devices 110, 115, 120, 125. Server(s) 130, database(s) 135, and/or database server(s) 140 may be located at one or more geographically distributed locations from each other or from client devices 110, 115, 120, 125. Alternatively, database(s) 135 may be included within server(s) 130 or database server(s) 140.

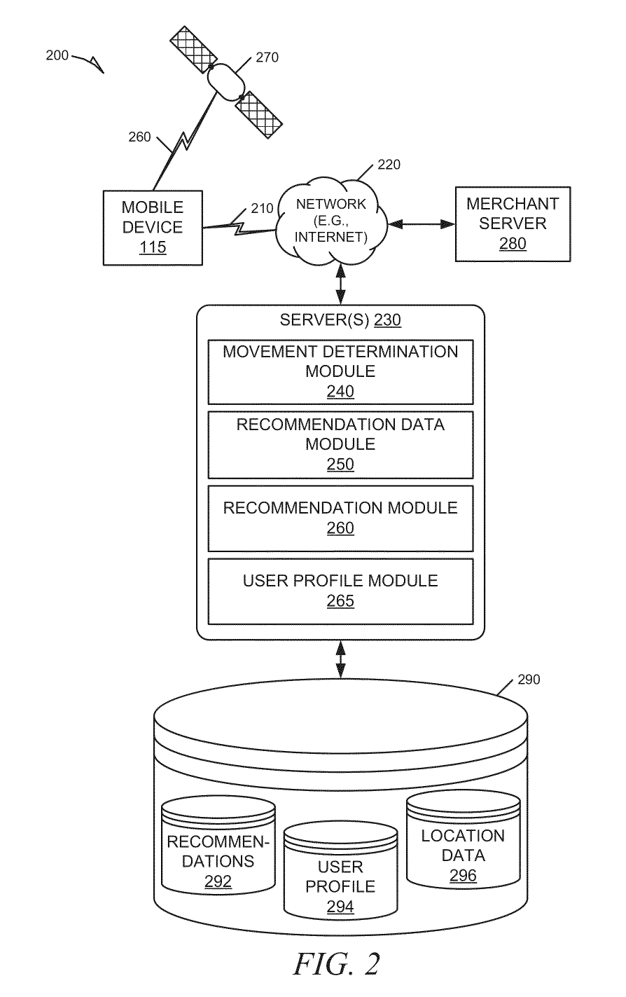

FIG. 2 is a block diagram illustrating an example environment 200 for operating a mobile device to provide recommendations. The environment 200 is an example environment within which methods of providing recommendations can occur. The environment 200 can include a mobile device 115, a communication connection 210, a network 220, servers 230, a communication satellite 270, a merchant server 280, and a database 290. The servers 230 can optionally include a movement determination module 240, a recommendation data module 250, a recommendation module 260, and a user profile module 265. The database 290 can optionally include recommendation databases 292, user profile database 294, and/or location data database 296. The mobile device 115 represents one example device that can be utilized by a user to receive recommendations and deals based on the user's location and movement. The mobile device 115 may be any of a variety of types of devices, for example, a cellular telephone, a personal digital assistant (PDA), a portable navigation system, a navigation system installed in a car, a handheld computer, a tablet computer, a notebook computer, or other type of movable device. The mobile device 115 may also be a portable navigation system like a GPS device or a navigation system that is installed in a vehicle. For example, some cars have a navigation interface and system installed in the car that a user can operate while in the car. Such systems include hardware and software that can operate the methods and systems described herein. The mobile device 115 may interface via a connection 210 with a communication network 220. Depending on the form of the mobile device 115, any of a variety of types of connections 210 and communication networks 220 may be used.

For example, the connection 210 may be Code Division Multiple Access (CDMA) connection, a Global System for Mobile communications (GSM) connection, or other type of cellular connection. Such connection 210 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 220 may include a cellular network that has a plurality of cell sites of overlapping geographic coverage, interconnected by cellular telephone exchanges. These cellular telephone exchanges may be coupled to a network backbone (for example, the public switched telephone network (PSTN), a packet-switched data network, or to other types of networks).

In another example, the connection 210 may be Wireless Fidelity (Wi-Fi, IEEE 802.11x type) connection, a Worldwide Interoperability for Microwave Access (WiMAX) connection, or another type of wireless data connection. In such an embodiment, the communication network 220 may include one or more wireless access points coupled to a local area network (LAN), a wide area network (WAN), the Internet, or other packet-switched data network.

In yet another example, the connection 210 may be a wired connection, for example an Ethernet link, and the communication network may be a LAN, a WAN, the Internet, or other packet-switched data network. Accordingly, a variety of different configurations are expressly contemplated.

A plurality of servers 230 may be coupled via interfaces to the communication network 220, for example, via wired or wireless interfaces. These servers 230 may be configured to provide various types of services to the mobile device 115. For example, one or more servers 230 may execute the movement determination module 240, which interoperates with software executing on the mobile device 115, to provide location and movement based services to a user. The movement determination module 240 may be a hardware-implemented module which may be configured to receive sensor data from the mobile device 115 and determine user movement and location based on the sensor data. The movement determination module may use data associated with the mobile device's location to provide location-specific information, recommendations, notifications, interactive capabilities, and/or other functionalities to a user. For example, the movement determination module 240 can obtain location and movement information of the user of the mobile device 115, which can then be used to assist in generating recommendations and offers relevant to the user's location. In certain examples, the mobile device 115 may have some limited location determination capabilities that are accounted for and augmented by the movement determination module 240.

In some examples, the servers 230 can include a hardware-implemented recommendation data module 250 for obtaining information related to businesses and deals based on user movement and location. The servers 230 may also include a recommendation module 260 for organizing the information obtained by the recommendation data module 250 and identifying recommendations based on the user movement and location. In some embodiments, location and movement data can be provided by the movement determination module 240 to the recommendation data module 250 and the recommendation module 260. The servers 230 may also include a user profile module 265 for obtaining user preferences regarding recommendations. The recommendation module 260 may configure the recommendations based on the user preferences identified by the user profile module 265.

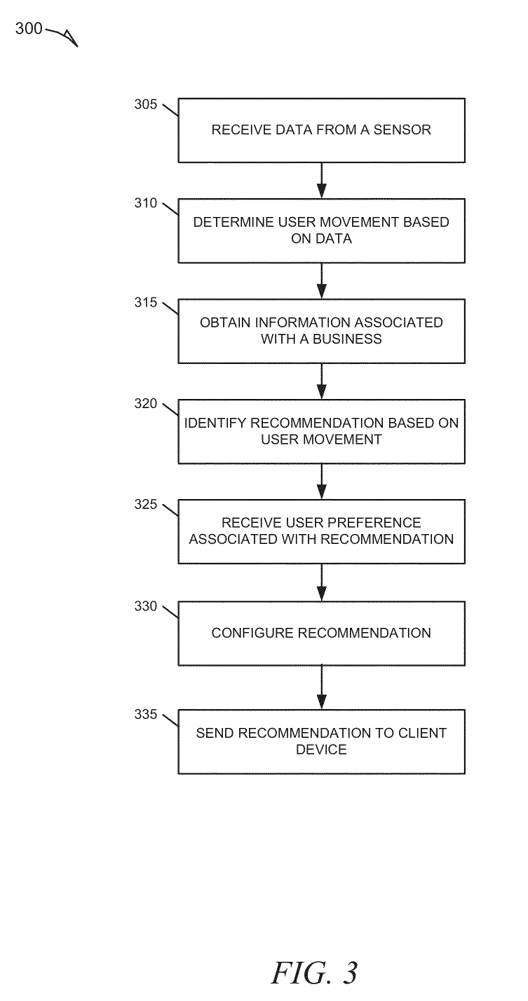

FIG. 3 is a flowchart illustrating an example method 300 for providing recommendations. The method 300 may be performed using the system 200 as shown in FIG. 2.

In operation 305, the movement determination module 240 receives data from a sensor. The sensor is included in a client device. The sensors may include sensors that detect and obtain data related to a location and a direction of movement of the client device. These sensors may include a GPS, a compass, and the like. The data obtained may include information regarding a current location of the client device, a previous location of the client device, a direction the client device is moving (east, west, north, south, etc.), a speed of the client device, and the like. The movement determination module 240 may temporarily store the received data for later use. In other embodiments, the movement determination module 240 may store the received data in a database as historical location data corresponding to the user.

In operation 310, the movement determination module 240 determines user movement based on the data from the sensors. The data from the sensors includes information corresponding to a location and direction of movement of a client device. The movement module 240 can use any appropriate factors to determine information associated with the user's location. The movement module 240 may use factors such as the location of the client device, the direction of the client device, the speed of the client device, and the like. In some embodiments, the movement module 240 may determine user movement information through interpolation based on different locations of the client device at different points in time. In some embodiments, the data from the sensors may include a location of the client device at various intervals of time. For example, at time T1, the sensor data indicates that the client device is at location L1. At time T2 the sensor data indicates that the client device is at location L2. At time T3 the sensor data indicates that the client device is at location L3, and so on. Based on the corresponding time and location, the movement determination module 240 can determine the speed at which the user is moving. The direction of movement can also be determined (e.g., if not provided by a sensor included in the client device). The movement determination module 240 can also determine a route or path that the user is traveling on.

The movement determination module 240 can determine whether the user is moving or the user is at least somewhat relatively stationary at a particular location. For example, a user may be driving from Texas to California. In that case, the movement determination module 240 uses the sensor data to determine that the user is driving. The sensor data may indicate that the user has been moving at a certain speed for a certain period of time. The movement determination module 240 determines from this data that the user is driving. It may also determine the route the user is driving on. In another example, a user may have reached a destination in California, such as San Jose. The movement determination module 240 determines that the user is done driving and has stopped in San Jose based on the sensor data. In this case, the sensor data indicates that the location of the client device is not changing as frequently as when the user was driving. The sensor data may also indicate that the user has been moving within San Jose and/or areas that are very close to San Jose.

In some embodiments, the movement determination module 240 can determine that the user is traveling by water in a boat or a ferry for example. In this case, the sensor data indicates that the user's location is in a body of water for a period of time. The movement determination module 240 can also determine that the user is traveling by air in a plane for example. In this case, the sensor data indicates that the user is moving at a high speed for a period of time. The sensor data may also indicate that the user started at location A and arrived at location B in a certain amount of time, and to arrive in that amount of time would likely involve taking a flight. Similarly, the movement determination module 240 can determine whether the user is traveling by a train. Depending on the mode of travel, the recommendation application identifies appropriate recommendations for the user.

In operation 315, the recommendation data module 250 obtains information associated with a business. Information associated with a business can include a name of the business, an address for the business, and the like. A business can include a gas station, a restaurant, a hotel, a tourist attraction, and the like. In some embodiments, the information may include additional information associated with the business, for example, a coupon, a deal, an offer, an item sold, a price for an item, hours of operation, and the like.

In an example embodiment, the recommendation data module 250 may communicate with applications, databases and/or servers that contain information regarding various businesses to obtain information associated with a business. For example, the recommendation data module 250 may communicate with a database hosted by a search engine to obtain a name of a gas station and an address for the gas station. The recommendation data module 250 may also communicate with a third-party application, which may have data associated with gas prices at that gas station.

In operation 320, the recommendation module 260 identifies a recommendation based on the user movement. The recommendation module 260 can identify a recommendation from the information obtained by the recommendation data module 250. The recommendation module 260 may go through the information obtained by the recommendation data module 250, and focus on businesses that are relevant to the user movement determined in operation 310. For example, if it is determined that the user is driving towards location A via a particular route, then information associated with businesses that are located on that route is obtained. If it is determined that the user has stopped at a particular location for a certain period of time, then information associated with businesses located in the particular location is obtained. As a specific example, if a user is driving from Texas to California on an interstate highway, the recommendation data module 250 may obtain information related to gas stations and restaurants that the user will pass on that interstate highway on his way to California. Once the user has reached California, and it is determined that the user is in San Jose, for example, then the recommendation data module 250 may obtain information related to gas stations and restaurants in San Jose, Calif.

In an example embodiment, the recommendation module 260 may identify different recommendations based on when the user is traveling versus when the user is stopped at a destination. For example, when the user is driving on an interstate highway, the recommendation module 260 may identify recommendations for gas stations and fast food restaurants. If the user is in a particular location for a period of time, then the recommendation module 260 may identify recommendations for restaurants and tourist attractions, since it is likely that the user is not interested or in need of gas stations. Rather the user is likely interested in tourism and dining at the particular location, since the user is likely visiting or vacationing there. In some embodiments, the recommendation module 260 may identify recommendations for hotels in a particular location for the first few days the user is in that particular location. It is likely that the user does not need a hotel on the third day of his stay in that location. For example, the user may have arrived in San Jose, Calif. and plans on staying there for a week. The recommendation module 260 may identify recommendations for a hotel for the first two days because the user likely needs a hotel. However, by the third or fourth day, the user has probably made arrangements for a hotel and is likely not interested in hotels. The recommendation module 260 may then identify recommendations for restaurants and tourist attractions.

In an example embodiment, the recommendation module 260 may identify recommendations based on the way the user is traveling. For example, if it is determined that the user is traveling by water, plane or train, the recommendation module 260 will not identify recommendations for gas stations because the user would not require gas in those cases. Instead, the recommendation module 260 may identify recommendations for hotels, restaurants and tourist attractions that may be near the user's possible destination.

In an alternative embodiment, the recommendation module 260 may identify recommendations associated with all businesses located on a route that the user is traveling or near the user's locations. In this case, the recommendation module 260 may not filter the recommendations based on when the user is driving versus when the user is stopped at a destination. The recommendation application may allow the user to select the type of recommendations he is interested in, and the recommendation module 260 may identify recommendations based on the user selection.

In some embodiments, the recommendation module 260 may identify recommendations based on the time of the day. For example, if it is night time then the recommendation module 260 may identify recommendations for a hotel, rather than a tourist attraction. If it is day time then the recommendation module 260 may identify recommendations for a tourist attraction and/or a restaurant. The recommendation module 260 may also identify recommendations based on the hours of operation of a business. The recommendation data module 250 may obtain information associated with a business, including hours of operations for the business. Based on this information, the recommendation module 260 may identify recommendations for a business that is open at the time. For example, if it is night time and a tourist attraction is open at that time, then the recommendation module 260 may identify a recommendation for the tourist attraction.

In some embodiments, the recommendation module 260 identifies updated recommendations based on user movement. For example, if a user is driving, then the recommendations identified by the recommendation module 260 at time T1 is probably not relevant to the user at time T2 because the user has probably driven past the businesses associated with the recommendations. The recommendation module 260 may identify updated recommendations every 10 to 15 minutes, as a default. The user can adjust how often the recommendation module 260 updates the recommendations.

In an example embodiment, operation 320 may occur before operation 315. For example the recommendation module 260 may identify recommendations based on user movement, and then the recommendation data module 250 obtains information associated with a business from the identified recommendations. The recommendation module 260 may identify gas stations and fast food restaurants on a route that the user is driving on. The recommendation data module 250 then obtains information associated with the identified gas stations and fast food restaurants. This reduces the information that the recommendation data module 250 has to obtain.

In operation 325, the user profile module 265 receives user preferences related to the recommendations. In some embodiments, the user can set preferences with respect to the recommendations. The user, for example, can indicate that he prefers a particular cuisine with respect to the recommendations for a restaurant. Similarly, the user can indicate that he prefers a particular gas station.

In operation 330, the recommendation module 260 configures the recommendations in any manner. In some embodiments, the recommendation module 260 may organize and rank the recommendations based on the user preferences. For example, if the user indicates that he prefers Italian food then the recommendation module 260 organizes the recommendations related to Italian food towards the top of the list. In some embodiments, the recommendation module 260 may not configure the recommendations according to user preferences if there is no preference indicated with respect to recommendations for a certain business type. The recommendation module 260 may organize the recommendations based on prices and/or coupons if available. For example, a recommendation for business that has coupons, sales, or deals available may be organized towards the top of the list. The recommendation module 260 may also organize the recommendations based on distance. For example, a recommendation for a business that is closer to the user's current location may be organized towards the top of the list.

In some embodiments, the recommendation module 260 configures the recommendations by associating an address with the business in the recommendation. For example, the recommendation module 260 may associate the address of a gas station obtained by the recommendation data module 250 with the gas station. In an example embodiment, the recommendation module 260 calculates the distance between the user and the gas station by using a current location of the user and the address of the gas station.

In some embodiments, the recommendation module 260 may use the distance between a business and the user to generate a warning to the user. For example, the recommendation module may identify a recommendation for a gas station that is located a few miles away from the user, and it may identify another recommendation for a gas station that is located very far from the user. In this case, the recommendation module 260 may generate a warning that notifies the user that there is a gas station close by and that the next gas station is located very far. This helps the user to realize that the he should stop for gas at the upcoming gas station because he may not make it to the next gas station depending on the amount of gas in his vehicle.

In operation 335, the recommendation module 260 sends the recommendations to the client device. The recommendation module 260 may send the configured recommendations to the client device, and the client device may display the recommendations as configured by the recommendation module 260. In some embodiments, the recommendation module 260 sends the address and the calculated distance to the client device, and the client device displays the distance associated with the business. In some embodiments, the client device may display the recommendations in a user interface using a font that is easy to read while traveling. The recommendations may be displayed as a list with a heading recognizing the type of recommendations. In some embodiments, the user interface may display the recommendations as icons on a map where the map represents the user's current location. In other embodiments, the user interface may display the recommendations in a list and display a ‘map’ button that the user can select to display the recommendations on a map. The recommendation module 260 may send information associated with the recommendations to the client device to enable the user interface on the client device to display the recommendations in a list and/or a map.

In some embodiments, the user may be able to select a recommendation associated with a business and obtain more details related to the business. For example, the user interface for the recommendation app may display a name of the business and an address of the business. In other embodiments, the user interface may display a directions button that a user may use to request directions. Selecting the directions button may launch a directions or a map application that may be included in the client device. The user can obtain directions to the business using this button and the application included in the client device. In other embodiments, the user interface may display an additional button which may launch an application or a web browser that may be included in the client device. In some embodiments, the name of the additional button may depend on the recommendation. For example, if the recommendation is for a gas station, then the additional button may be called ‘gas price.’ In this case, selecting the button may launch a web browser or an application that displays the gas price for that gas station. In another example, if the recommendation is for a restaurant, then the button may be called ‘coupons.’ Selecting this button may launch a web browser or an application that presents a coupon for that restaurant to the user.

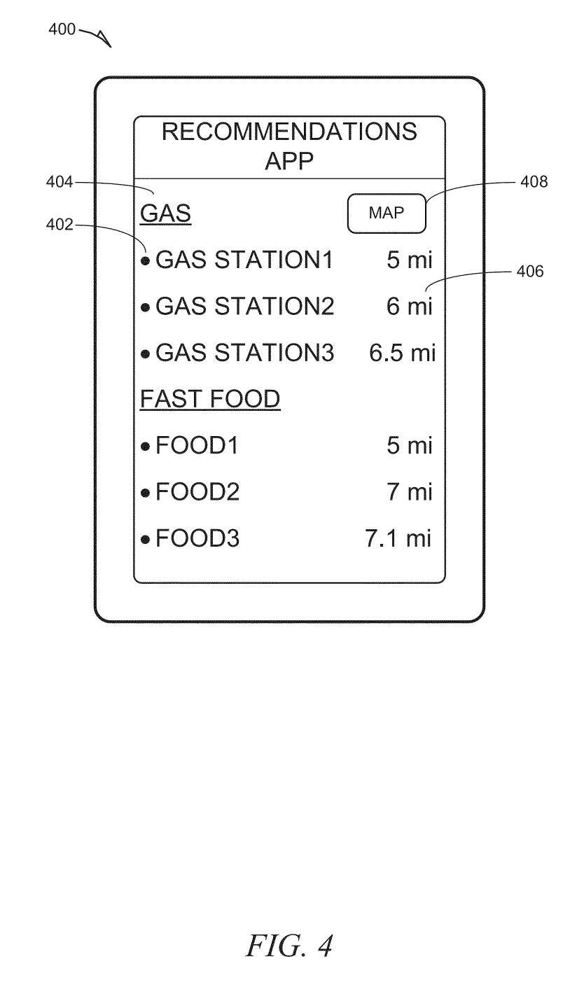

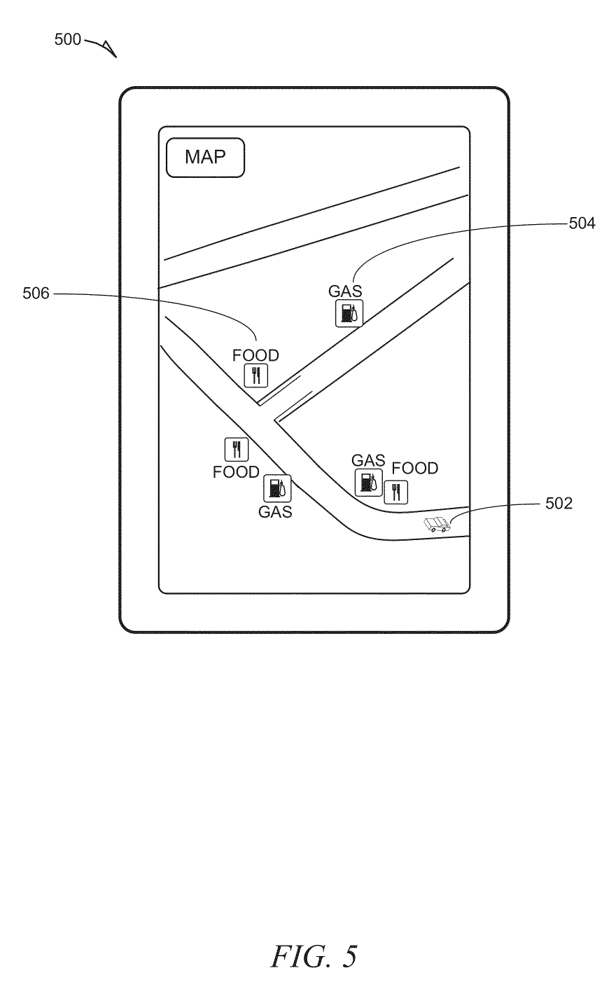

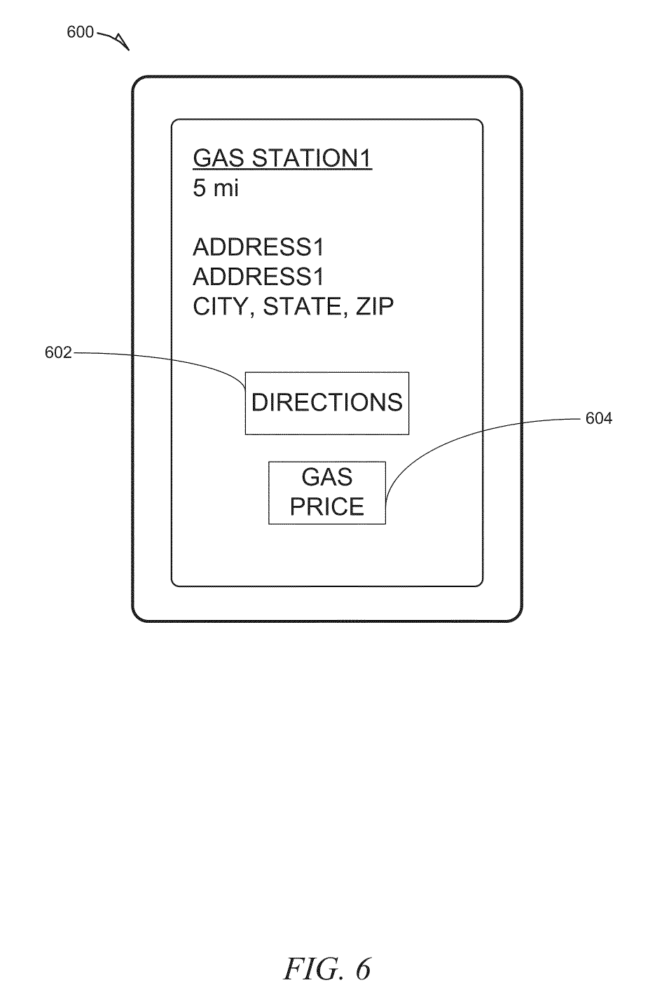

FIG. 4 is an interface diagram of an example user interface 400 for providing recommendations on a client device, according to some embodiments. User interface 400 may be an interface to display recommendations on a client device. User interface 400 displays the recommendations as a list, as illustrated by element 402. A heading indicating the type of recommendations is displayed as illustrated by element 404. A distance between the business and the user's location is displayed as illustrated by element 406. For example, user interface 400 displays a list of gas stations under a heading ‘gas’ and a list of fast food restaurants under the heading ‘fast food.’ In this example, gas station1 is 5 miles from the user's current location. User interface 400 can also display a ‘map’ button as illustrated by button 408. Selecting button 408 may display a map as shown in FIG. 5. The user may select a recommendation from the list. Selecting a recommendation displays more information as shown in FIG. 6. Although elements 402, 404, 406, and button 408 are shown at a certain location in the user interface 400, it is understood that they may be located anywhere in user interface 400.

FIG. 5 is an interface diagram of another example user interface 500 for providing recommendations on a client device, according to some embodiments. User interface 500 may be an interface to display recommendations in a map on a client device. User interface 500 includes a map of the user's current location. The user's current location is indicated by icon 502. User interface 500 includes an icon 504 indicating a recommendation for a gas station, and an icon 506 indicating a recommendation for a restaurant. The icons 504, 506 may indicate a geographic location on the map for a business. The geographic location can be determined by the address associated with the business.

FIG. 6 is an interface diagram of another example user interface 600 for providing recommendations on a client device, according to some embodiments. User interface 600 may be an interface to display additional information associated with a recommendation. In this example, user interface 600 displays additional information associated with a recommendation for gas station1. User interface 600 includes a ‘directions’ button 602. Selecting button 602 may launch a directions application included in the client device. User interface 600 includes a ‘gas price’ button 604. Selecting button 604 may launch a web browser or an application that displays a gas price for the gas station1. Although button 602, 604 are shown at a certain location, it is understood that they may be located anywhere in user interface 600.

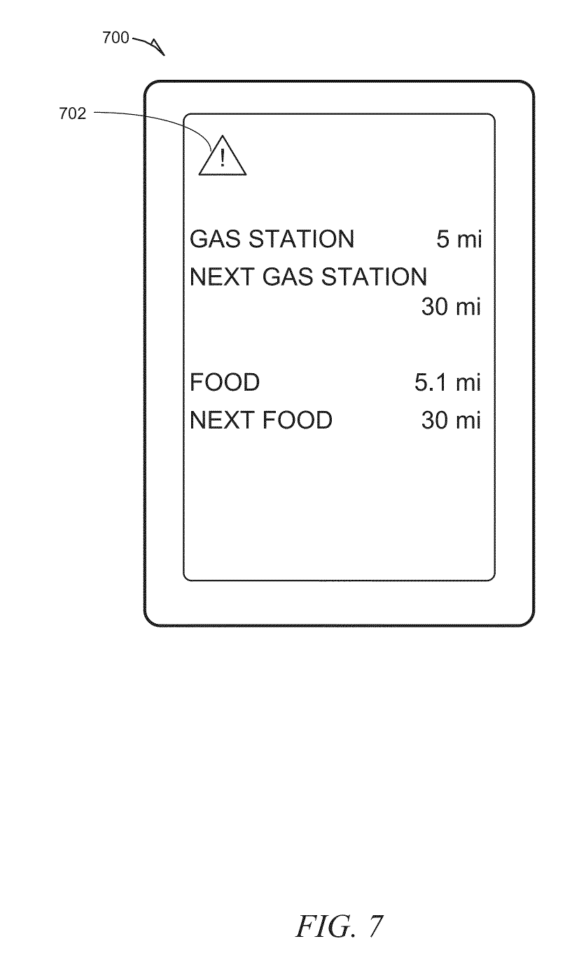

FIG. 7 is an interface diagram of another example user interface 700 for providing recommendations on a client device, according to some embodiments. User interface 700 may be an interface to display a warning to the user. User interface 700 includes a warning icon 702. In this example, user interface 700 indicates to the user that there is a gas station located 5 miles away, and the next gas station is 30 miles away. Because of the remoteness of the next gas station, icon 702 is displayed to warn the user. Although warning icon 702 is shown at a certain location in user interface 700, it is understood that it may be located anywhere in user interface 700.

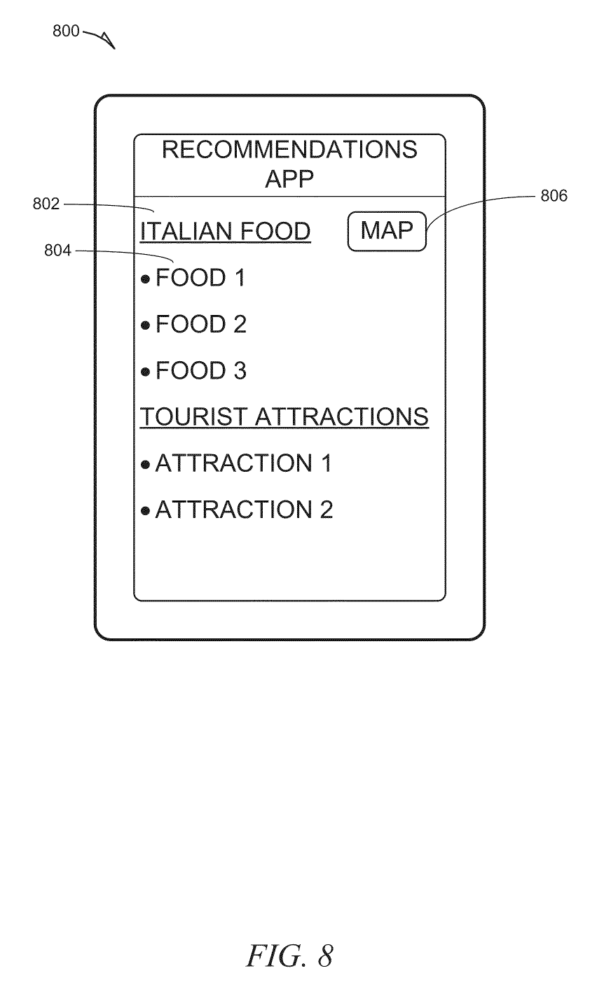

FIG. 8 is an interface diagram of another example user interface 800 for providing recommendations on a client device, according to some embodiments. User interface 800 may be an interface to display recommendations in a list according to user preferences. User interface 800 includes recommendations for Italian food as illustrated by element 802 and element 804. A ‘map’ button 806 is also included. Selecting button 806 may display the recommendations in a map. Although elements 802, 804 and button 806 are shown at a certain location in the user interface 800, it is understood that they may be located anywhere in user interface 800.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

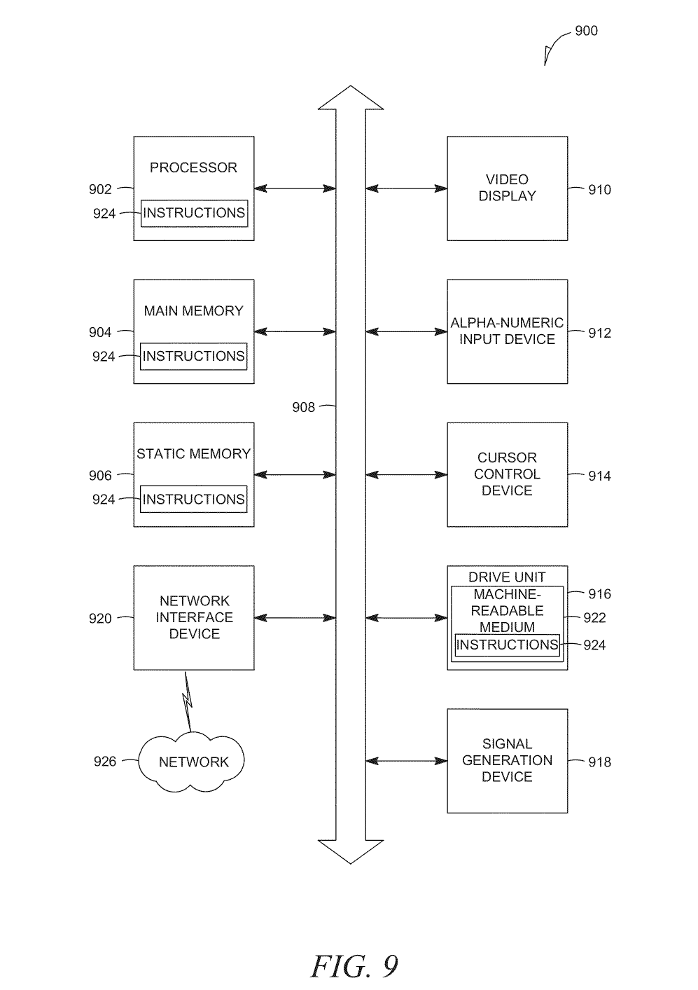

FIG. 9 is a block diagram of machine in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions and data structures (e.g., software) 924 embodying or used by any one or more of the methodologies or functions described herein. The instructions 924 may also reside, completely or at least partially, within the main memory 904, static memory 906, and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies described herein, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although a mechanism for providing recommendations has been described with reference to specific example embodiments, it will be evident that various modifications and changes may be made to these embodiments without departing from the broader spirit and scope of the mechanism. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the mechanism. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the subject matter may be referred to herein, individually and/or collectively, by the term “mechanism” merely for convenience and without intending to voluntarily limit the scope of this application to any single embodiment or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system for providing a recommendation to a client device comprising:
a hardware-implemented user movement module configured to:
receive sensor data from a sensor on the client device, the sensor data indicating a location and a direction of the client device;
determine user movement information based on the sensor data; and
a hardware-implemented recommendation module configured to identify the recommendation based on the user movement information and send the recommendation to the client device.

2. The system of claim 1, wherein the sensor is a GPS sensor.

3. The system of claim 1, wherein the sensor is a compass sensor.

4. The system of claim 1, wherein the recommendation module is configured to send the recommendation to the client device based on a user preference.

5. The system of claim 1, wherein the recommendation is associated with a business.

6. The system of claim 1, wherein the recommendation includes information associated with at least one of a gas station, a restaurant, a hotel, and a tourist attraction.

7. The system of claim 1, wherein the user movement information includes a particular geographic region associated with the location of the client device.

8. The system of claim 1, wherein the recommendation module is configured to obtain information from at least one of a website, a database, and an application server, the recommendation being based on the information.

9. A method for providing a recommendation to a client device based on user movement, the method comprising:
receiving sensor data from a sensor on the client device, the sensor data indicating a location and a direction of the client device;
determining user movement information based on the sensor data;
identifying the recommendation based on the user movement information;
sending the recommendation to the client device.

10. The method of claim 9, wherein determining the user movement information includes determining a length of time associated with the user movement information.

11. The method of claim 9, further comprising:
identifying a predicted route of the user using the user movement information, wherein identifying the recommendation includes determining one or more entities associated with the predicted route.

12. The method of claim 9, wherein determining the user movement information includes determining a particular geographic region associated with the location of the client device.

13. The method of claim 12, wherein the recommendation is specific to the particular geographic region.

14. The method of claim 12, wherein determining of the user movement information includes determining that the user has been in the particular geographic region for a predetermined amount of time and wherein the recommendation is associated with the particular geographic region.

15. The method of claim 9, further comprising:
receiving updated sensor data;
detecting a change in the user movement information based on the updated sensor data; and
identifying a second recommendation based on the change in the user movement information.

16. A non-transitory machine-readable storage medium comprising a set of instructions that, when executed by one or more processors, causes the one or more processors to perform operations comprising:
receiving sensor data from a sensor on a client device, the sensor data indicating a location and a direction of the client device;
determining user movement information based on the sensor data;
identifying a recommendation based on the user movement information; and
sending the recommendation to the client device.

17. The non-transitory machine-readable medium of claim 16, wherein the recommendation includes information associated with at least one of a gas station, a restaurant, a hotel, and a tourist attraction.

18. The non-transitory machine-readable medium of claim 16, wherein identifying the recommendation includes obtaining information from at least one of a website, a database, and an application server, the recommendation being based on the information.

19. The non-transitory machine-readable medium of claim 16, wherein determining of the user movement information includes determining that the user has been in the particular geographic region for a predetermined amount of time and wherein the recommendation is associated with the particular geographic region.

20. The non-transitory machine-readable medium of claim 16, wherein the set of instructions cause the one or more processors to perform further operations comprising:
identifying a predicted route of the user using the user movement information, wherein identifying the recommendation includes determining one or more entities associated with the predicted route.
